(19) United States
(12) Patent Application Publication
(10) Pub. No.: US 2005/0044892 A1
(43) Pub. Date: Mar. 3, 2005

(54) Method and apparatus for heating glass sheets

(76) Inventor: Stephan P. George II, Perrysburg, OH (US)

Correspondence Address: MARSHALL & MELHORN, FOUR SEAGATE, EIGHT FLOOR, TOLEDO, OH, 43604, US

(21) Appl. No.: 10/858,095

(22) Filed: Jun. 1, 2004

Related U.S. Application Data
(60) Provisional application No. 60/498,416, filed on Aug. 28, 2003.

(51) Int. Cl. C03B 32/00

(52) U.S. Cl. 65/29.19; 65/162

(57) ABSTRACT

Automatic heating controls for heating of glass sheets and methods utilizing such controls are provided so that area temperatures approach plus or minus 1 degree Fahrenheit of area desired temperatures, in a steady state operation through a furnace having heaters. Area temperatures and area desired temperatures are combined to obtain area temperature errors. The area temperature errors, area setpoint temperatures, and a comparison of adjacent area temperatures and/or area setpoint temperatures are then applied to integral-only feedback control so as to provide area furnace system demand. For thick glass (i.e., greater than approximately 3 mm thickness) core temperatures are included to obtain temperature errors. Then, area furnace system demand is utilized to adjust the heat output of the heaters, the speed of the transport system, or both. Following a gap in the flow of glass sheets, the area temperatures are returned to steady state operation within 10 minutes.

### RELATED APPLICATIONS

This application claims the benefit, under 35 U.S.C. § 119(e), of U.S. Provisional Patent Applications Ser. No. 60/498,416, filed Aug. 28, 2003 under 35 U.S.C. § 111(b), which application is incorporated herein in its entirety.

### BACKGROUND OF THE INVENTION

The present invention relates to heating a glass sheet as it is being transported through a furnace. More particularly, the present invention relates to automatic controls and methods for heating a plurality of glass sheets as they are being transported through a furnace.

Glass sheets of varying thickness, for example, thin automotive windshield glass and thicker glass intended for heat strengthening, such as for automotive side lites, are heated prior to and/or during tempering, annealing, or bending. Typically, the sheets are conveyed through a furnace having a plurality of heaters that impart heat to the sheets. Generally, temperature setpoint devices are electrically connected to such heaters for regulating the heat output of each heater within the furnace.

Also, it is common to control the rate of movement of the glass sheets through the furnace, since the speed, direction (as in the case of systems using reciprocating conveyors), and manner in which the glass sheets are transported, have significant effects on the heating and thus the quality of the sheets.

In the past, the adjustment of the temperature setpoint devices and the control of the glass sheets' movement were manually set and then manually changed after the yield or quality of the glass sheets appeared to have degraded. This method of dealing with the heating of glass sheets resulted in substantial product loss before yield and quality returned to the desired levels.

U.S. Pat. No. 4,071,344 to Blausey addresses some of these deficiencies by applying semi-automatic control to the heating of the glass sheets and seeking to overcome the “lagging heat input response, i.e., a time delay before the adjusted thermal input is adequately reflected in the heating atmosphere and imparted to the advancing glass sheets.” To this end, Blausey uses an infrared thermometer to view heated sheets in order to obtain a sheet average output temperature. The average output temperature is then used to vary the speed of a glass sheet conveyor and to adjust the heater setpoint temperatures.

U.S. Pat. No. Re. 32,497 to Canfield uses a furnace having an array of individual heaters and employs a video imager to scan the heated sheets in order to provide a thermal profile of the sheets. This profile is subsequently output to individual “three mode PID [proportional-integral-derivative] temperature control[s]” for controlling each heater. Canfield also employs motor controllers to control conveyors that move the sheets through the furnace.

U.S. Pat. No. 4,807,144 to Joehlin et al. reads temperature signals in a glass sheet processing system that are then compared to a threshold temperature. The number of such readings that exceeds the threshold temperature are stored and if that number of readings exceeds a predetermined set size, then the system calculates the average temperature of the set. This average is then included with other averages and displayed for manual control and may be used to increment/decrement the furnace setpoint temperatures.

Although Blausey, Canfield, and Joehlin provide some measures of automatic control, the control of the heating and movement of the heated glass sheets is more complex than recording an average temperature of several glass sheets and sending such information to setpoint devices or sending the thermal image profile information on glass sheets to individual heaters.

Even with the controls of Blausey, Canfield, and Joehlin, wide swings in glass sheet temperatures (from one sheet to the next or between a series of sheets) result in long delays before the glass sheet temperatures approach desired (target) temperatures. This, in turn, results in reduced yield and poor quality of the glass sheets. Currently, the automotive in dustry does not tolerate optical quality variations in, for example, windshields. However, wide swings in sheet temperatures and delays in approaching desired temperatures can result in such optical variation.

Some conditions that can cause wide temperature deviations, which average temperature monitoring and temperature profiling do not completely address, are: a) hot and cold air drafts within the furnace, b) variations in the ambient atmospheric temperature, pressure, and humidity, c) variations in the composition of the glass sheets, d) furnace inefficiencies and inherent differences in heating effects between heating elements, and e) gaps in the flow of glass sheets being transported through the glass sheet heating system.

Thus, those skilled in the art continue to seek a solution to the problem of how to provide better controls and methods to control heating of glass sheets being transported through a furnace.

### SUMMARY OF THE INVENTION

The present invention relates to a glass sheet heating system that has automatic controls and methods for heating glass sheets to area temperatures that approach desired temperatures as the glass sheets are transported by a transport system in an enclosure having heaters.

The controls and methods include combining area temperatures and desired temperatures to obtain temperature errors. Further, the temperature errors, setpoint temperatures, and area temperature-differences and/or area setpoint temperature differences are applied to integral-only feedback control to obtain furnace system demand that thermally drives the glass sheet heating system. For thick glass sheets (i.e., approximately 3 mm or greater thickness) core temperatures may be included in determining the temperature errors.

The furnace system demand thermally drives the glass sheet heating system by adjusting the speed of the transport system, or the heat output of the heaters, or both. Thereby, the sheets are heated within area temperature tolerances of plus or minus 1 degree Fahrenheit of the desired temperatures for steady state operation and return to these tolerances within 10 minutes of a return from a gap in sheet conveyance.

Further objects and advantages of the present invention will be apparent from the following description and appended claims, reference being made to the accompanying drawings forming a part of a specification, wherein like reference characters designate corresponding parts of several views.

### BRIEF DESCRIPTION OF THE DRAWINGS

FIG. 1 is a top plan view of a heating panel having areas in accordance with the present invention;

FIG. 2 is a side plan view of a glass sheet heating system including the heating panel in accordance with the present invention; and

FIG. 3 is a top plan view of the glass sheet heating system of FIG. 2.

### DETAILED DESCRIPTION OF THE PREFERRED EMBODIMENTS

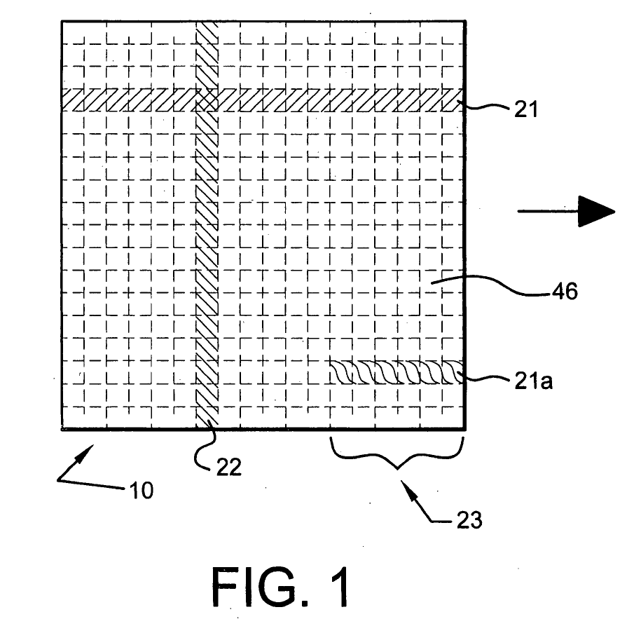

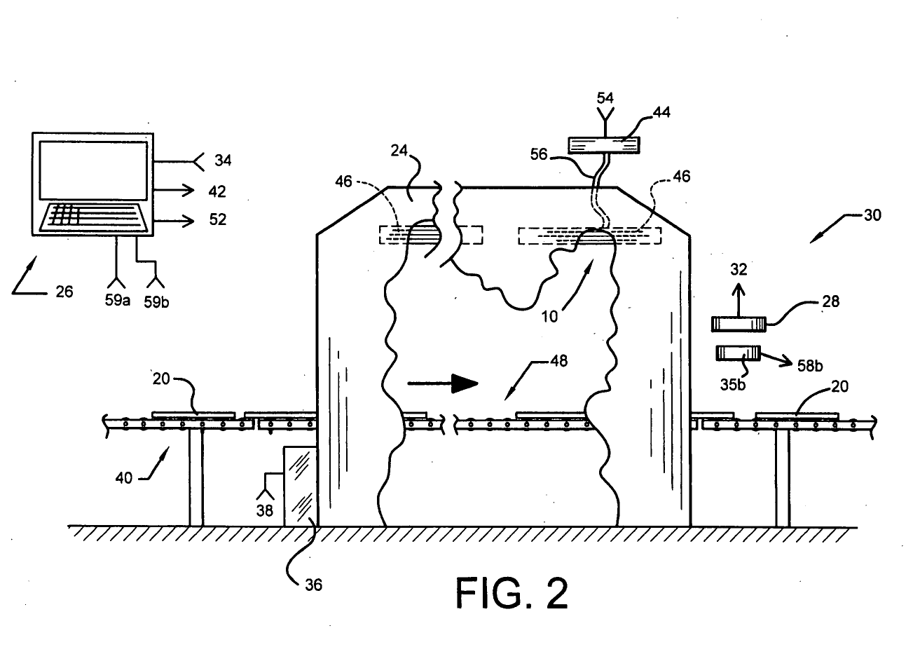

FIG. 1 is a top plan view of possible area layouts for a heating panel 10. In a preferred embodiment of the present invention the areas of primary concern are lanes 21, which are defined as heating areas that are parallel to the direction of travel (as shown by the arrow) of a glass sheet 20 within a furnace 24 (see FIG. 2). Heaters 46 may be positioned, wired, and controlled: a.) within each lane 21 (preferred), or b.) at the intersection of each lane 21 and row 22 (as in U.S. Pat. No. Re. 32,497 to Canfield), or c.) in any configuration of lanes 21, lane portions 21a, rows 22, and/or zones 23.

The rows 22 are defined as heating areas that are transverse to the direction of travel of the glass sheet 20, as the sheet 20 is transported through the furnace 24. The zones 23 are defined as groupings of rows 22. The lane portions 21a are defined as those parts of a particular lane 21 that are within a particular zone 23. Note that even though the preferred areas are lanes 21, the present invention is not limited by the definition of the area.

The above-mentioned lanes 21 of the heating panel 10 correspond to like lanes 21 on the glass sheets 20 as the sheets 20 pass by and are heated by the heaters 46 and subsequently thermally scanned to obtain lane (area) temperatures. The varying widths of the glass sheets 20 that may be processed in the furnace 24 do not necessarily span the entire width of the heating panels 10, but the present invention is capable of determining lane temperatures notwithstanding such size differences.

FIG. 2 is an illustration of a side plan view of a glass sheet heating system 30, where the glass sheets 20 are transported through the furnace 24 on a transport system 40, for example a conveyor. The furnace 24, which typically is enclosed, has a plurality of heaters 46, for example, dome heaters, that-provides the source of heat that is imparted to the glass sheets 20. As shown, some of the heaters 46 may be disposed near the exit end of the furnace 24, and above the conveyor 40 and the glass sheets 20. However, the heaters 46 may be disposed throughout the furnace 24 as required and need not be confined to heating panels 10.

Also shown in FIG. 2 is at least one processor 26, for example, a microcomputer, which is in communication with at least one conveyor control 36 by way of a processor-conveyor output port 42 connected to a conveyor input port 38. The processor 26 is also in communication with at least one heater setpoint device 44 by way of a processor-setpoint output port 52 connected to a setpoint input port 54. The heaters 46 communicate with the setpoint device 44 by way of a setpoint-heater interconnection 56. Further, the processor 26 is in communication with at least one thermal scanning device 28 by way of a processor-scanner input port 34 connected to a scanner output port 32.

As shown, the scanning device 28, for example, an infrared thermal scanner, is disposed at the exit of the furnace 24, however, the scanning device 28 may be disposed in various positions, and still remain within the spirit and scope of the present invention. The scanning device 28 typically is essentially continuously viewing (known in the art as “seeing scan lines”) the glass sheets 20 (in lanes 21) as the sheets 20 exit the furnace 24, and essentially continuously communicating thermal signals (images) of the glass sheet 20 to the processor 26 for precise heating.

From the thermal images of the glass sheet 20, the processor 26 obtains a plurality of discrete area temperatures on the glass sheet 20. The locations of these discrete glass sheet area temperatures correspond to the aforementioned discrete heating lanes.

In a particularly preferred embodiment, the present invention measures the lane temperatures on the glass sheets 20 as they exit the furnace 24, wherein the discrete lane-temperatures are obtained. Consequently, the resulting lane (area) temperatures are then utilized to more precisely control specific heaters 46 that correspond to these glass sheet areas 21. As noted earlier, there may be fewer lanes 21 associated with the glass sheet 20 than are available across the width of the furnace 24.

Further, the system 30 compares each current lane (area) temperature and/or current lane (area) setpoint temperature to those of other lanes (preferably lanes that are immediately adjacent to the specific lane) so as to compensate the current lane (area) temperature for a thermal effect (known in the art as thermal crosstalk) of these adjacent lanes.

This comparative process results in adjacent area temperature differences and/or adjacent area setpoint temperature differences that are utilized to determine furnace system demand, which, in turn, is utilized to adjust the speed of the transport system, or the heat output of the heaters, or both. Note that the comparing process may be implemented as a comparator (not shown) in hardware, software, or a combination of both. Also, the processor may comprise the comparator.

It should be appreciated that in compensating for thermal crosstalk, the present invention is not limited to only adjacent lanes. However, not wishing to be bound by any theory, it is believed that a consideration of lane temperature differences, especially adjacent lane (area) temperature differences and adjacent lane (area) setpoint temperature differences, is important in controlling the temperature of glass sheets 20 being heated in the glass sheet heating system 30.

Further, the process may combine the lane temperature and desired (target) temperature, which results in the lane (area) temperature error. The temperature error, the current lane setpoint temperature, and the above-stated adjacent lane temperature differences and/or adjacent lane setpoint temperature differences may be applied to a feedback controller (not shown), which preferably is an integral-only feedback controller operating in a closed loop fashion.

The application of the integral-only feedback control may be utilized to provide at least a portion of the furnace system demand that thermally drives the glass sheet heating system 30 to heat the glass sheets 20 to lane temperatures that are within lane (area) temperature tolerances of the desired temperatures. The furnace demand is utilized in controlling the heaters 46, the conveyors 40, or both. Also, in the present invention, the integral-only feedback controller and the comparator may be implemented separately or in combination to provide the furnace system demand.

Note that the desired temperatures may be adaptively mathematically provided as the glass sheets 20 are transported through the system 30, established historically, or a combination thereof. Also, the desired temperatures may be preloaded or manually input to the processor 26, while being specific to the type of glass sheets 20 being heated.

As described, the glass sheet heating system 30 is capable of attaining glass sheet steady state lane (area) temperatures that are within lane (area) temperature tolerances (i.e., a range of plus or minus 1 degree Fahrenheit) of the desired temperatures.

These results are achieved even under the conditions of: a) hot and cold air drafts within the furnace 24, b) variations in the ambient atmospheric temperature, pressure, and humidity, c) variations in the composition of the glass sheets 20, and d) varying efficiencies and capabilities of the furnace 24 and the heaters 46.

In general, feedback controllers utilize PID (proportional-integral-derivative) control techniques. However, utilizing the proportional feedback portion in the instant application has been found to provide little if any stable temperature control of the heated glass sheets 20 within the glass sheet heating system 30, especially when considering thermal-recovery from an absence of glass sheets 20 flowing in the system 30. Further, utilizing the derivative feedback portion has been found to produce undesirable oscillatory effects on the temperature control of the system 30.

As a result, the integral-only feedback controller is employed in the present invention to result in stable control of the system 30. Note that in the present invention the feedback controller, which is in communication with the processor 26, may be implemented in hardware or software, or a combination of both, and that the processor 26 may comprise the feedback controller.

From the lane (area) furnace system demand that results from applying the lane (area) temperature errors, the lane (area) setpoint temperature, and the adjacent lane (area) temperature differences and/or adjacent lane (area) setpoint temperature differences (i.e., the output of the comparator)., the processor 26 essentially continuously adjusts the speed of the conveyors 40 by way of the conveyor controller 36, or the heat output of the heaters 46 by way of the setpoint devices 44, or both.

In the present application, the processor 26 includes control software, known in the art as advanced control software that is adaptable to varying system parameters, like those of the glass sheet heating system 30. However, the present invention is not limited by the control software package or the software format that is used for implementation.

The control software communicates with the thermal scanning device 28, which may be connected by any means common in the art, for example, wire or wireless. It may be appreciated in the present invention, that the connecting of system parts is not limited by the connecting means.

Not wishing to be bound by any theory, it is believed that the control of the heating of the glass sheets 20, within the glass sheet heating system 30, is affected by a non-continuous flow of the discrete glass sheets 20, either under the presence of glass sheet operations or under the absence of glass sheet conditions. For the most part, previous glass sheet heating systems appear to have treated the glass sheet flow as being a continuous flow process.

In the present invention, however, even the environmental and transportation conditions within the furnace are treated as non-continuous flow conditions, for example, the non-uniformity of the heat imparted to the glass sheet areas 21-23 (i.e., variations in heater element wattages, proximity of the glass sheet 20 to various heater elements, variations in air currents, maintenance of heater elements, physical asymmetries within the furnace 24, reciprocal movement of the sheets 20, to mention only a few) continuously varies as the glass sheet 20 is transported through the furnace 24.

Because of these complex and ever changing conditions, taking an overall average temperature of the glass sheet 20, as in U.S. Pat. No. 4,071,344 to Blausey, obtaining a thermal profile of the sheet 20, in conjunction with three mode PID temperature controllers, as in Canfield, or utilizing a number of average temperatures exceeding a threshold temperature, as in U.S. Pat. No. 4,807,144 to Joehlin, does not provide the comprehensive control required of the glass sheet heating system 30. Currently, the automotive industry requires this very comprehensive control, for example, producing automotive windshields that are virtually free of optical defects.

In addition to obtaining area (i.e., surface) temperatures that are primarily on or near a surface of the glass sheet 20, it is known in the art that glass core temperatures may also be important in controlling the heating of the glass sheet 20. In general, the thicker the glass sheet 20, the more important it is to obtain the temperature of the core of the sheet 20 (i.e., temperature not near to or on the surface of the glass).

As a comparison, it may be adequate for the system 30 to only obtain the area temperature on a surface of relatively thin glass, for example, 1.7-2.2 mm thick automotive windshield glass, whereby the scanner 28 utilizes electromagnetic signals, for example, in the 4.5 to 5 micron range, received from the heated glass 20 and then communicates these signals on to the processor 26, which in turn obtains the area temperature on the surface of the glass. The present invention, however, is not limited by the type and/or wavelength of the scanner 28 and its signals that are used to determine the various temperatures.

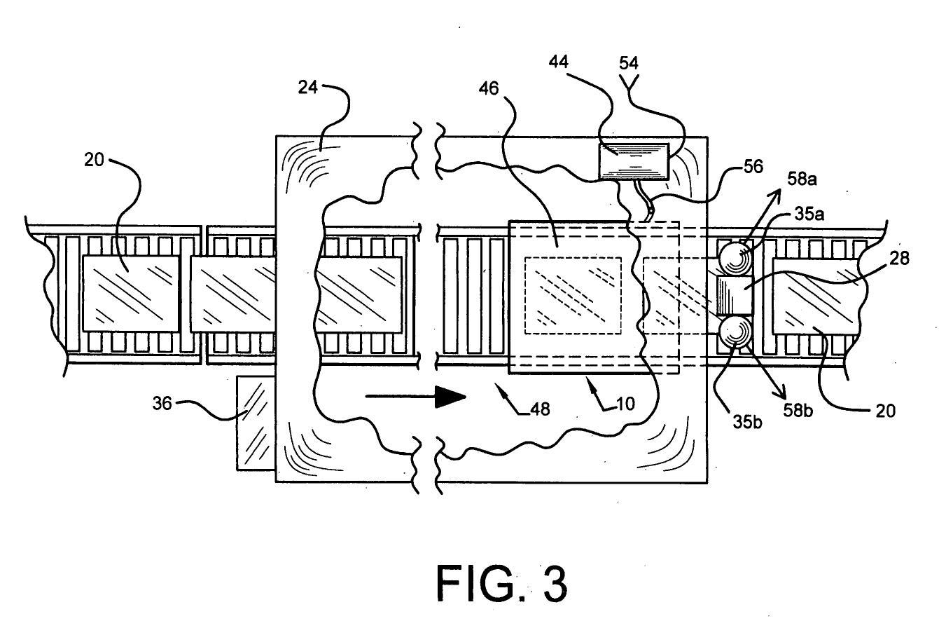

However, for relatively thick glass sheets 20, like 3-5 mm thick automotive side lites, back lites, and sun roofs, in addition to obtaining the area temperature on or near the surface of the glass sheet 20, in the manner described for the windshield, the system 30 may need to employ one or more spot pyrometers 35a, 35b to obtain core temperatures. As shown in FIGS. 2 and 3, two spot pyrometers 35a, 35b are disposed above the conveyor 40 and the glass sheets 20, and external to the furnace 24 at the furnace exit. For the pyrometers 35a, 35b that were utilized in the present invention, the electromagnetic wave signals received from the heated glass 20 were in about the 3.5 micron wavelength range. Then, these pyrometer signals are communicated to the processor 26, which in turn obtained the core temperature. The present invention, however, is not limited by the choice or placement of the pyrometers 35a, 35b.

In obtaining the core temperature of the thicker glass sheets 20, the pyrometers 35a, 35b essentially continuously communicate signals to the processor 26, by way of processor-pyrometer input ports 59a, 59b that are connected respectively to pyrometer output ports 58a, 58b. For the pyrometers 35a, 35b that were utilized in the present invention, the electromagnetic wave signals received from the heated glass 20 were in about the 3.5 micron wavelength range. These pyrometer signals were then communicated to the processor 26, which in turn obtained the core temperature. The present invention, however, is not limited by the number, type, and/or wavelength of the pyrometers 35 and their signals that are used to determine the various temperatures.

Having both the area surface temperature and the core temperature, for the thicker glass sheets 20, the system 30 combines the area surface temperature, the core temperature, and the desired temperature to result in the area temperature error. As stated above, the area temperature error is then applied, along with the current area setpoint temperature and the adjacent area temperature differences and/or adjacent area setpoint temperature differences, to the integral-only feedback controller. An area temperature gradient that results from this process is controlled by the controller 26 through at least the control of furnace setpoint temperatures and line speed.

Thereby the system 30 factors in the heat capacity effect of the glass below the surface of the glass sheet 20 in the area under control. This results in accurately controlling area surface temperature to core temperature gradient (profile) for the thicker glass sheets 20.

Beyond proper thermal handling of the steady state flow of the glass sheets 20, the present invention improves the temperature control of a non-steady state glass flow condition, which is known as a gap 48 (see FIGS. 2-3). Gaps, in general, have been a significant problem for glass sheet heating controls. The gap 48 may be the result of, for example, unavailability of glass sheets 20 entering the system 30, a breakdown of the glass sheet heating system 30, or a start up of a flow of a new batch of glass sheets 20.

When thermally dealing with the return of glass sheets 20 to the glass sheet heating system 30 following the gap 48, the system 30 may, for example, need to: a) supply added heat to the glass sheets 20, b) stop supplying heat to the glass sheets 20, c) cool the glass sheets 20 (although addressed by others in the art, controlled cooling is not provided in the present invention but controlled cooling could fall within the scope and spirit of the present invention), and/or d) change conveyor speed. Associated with these needs is the ability to quickly thermally obtain and maintain the desired reaction, i.e. to control area and/or core temperatures that are within area temperature tolerances of desired temperatures.

In order to minimize the negative impact of the gaps 48 upon system yield and glass sheet quality, the system 30 utilizes mathematical thermal modeling of furnace heating, for example, a) for a full steady state furnace 24, b) for a furnace 24 that is heating up due to the occurrence of the gap 48, c) for an empty steady state furnace 24, and d) for a cooling down furnace 24 that is recovering from the gap 48.

The system 30 senses the presence of the gap 48, for example, when the scanning device 28 does not receive the electromagnetic signals from the glass sheet 20 or by not sensing the glass sheets 20 by other means common in the art. Conversely, the system 30 senses the flow of glass sheets 20, for example, when the scanning device 28 receives the electromagnetic signals from the glass sheets 20 or by sensing the glass sheets 20 by other means common in the art. Throughout these processes, the system 30 utilizes the adjacent area temperature differences and/or adjacent area setpoint temperature differences, along with the integral-only feedback control, to anticipate the return to desired steady state conditions.

Note that it is of particular importance in the present invention that the integral-only feedback-control is utilized in stably handling gaps and recovery from gaps. Thus, the system 30 provides glass sheets having area temperatures that are plus or minus 1 degree Fahrenheit (the area temperature tolerance) of the desired temperatures, returning within 10 minutes of the sensing of an absence of the gap 48.

This results in a great improvement over an open loop controlled glass sheet heating system, or a closed loop controlled system that does not incorporate the features of the present invention. Without the present invention's controls, it can take an hour or more to stabilize the heating process following gap recovery.

Only recently has it become practical to provide the enormous processing power that is required to achieve the above stated control, in a real-time framework. Factors to support this position are the speed of the central processing unit (CPU), the type of computer the CPU is running on, and the capability of the computer's operating system.

Specifically, the present invention and the art over the last fourteen to twenty-five years, i.e., respectively Joehlin (1989), through Canfield (1987), and to Blausey (1978), can be compared on a practical basis through the use of an Intel™ CPU running on an IBM™ compatible personal computer using an associated Microsoft™ operating system. Note that the present invention is, however, not limited to this Intel/IBM/Microsoft computer system configuration.

Referring to the present invention, the minimum Intel/IBM/Microsoft computer system configuration that has been found capable of successfully running the above-stated controls and methods are an IBM compatible personal computer operating at 733 MHz with an Intel™ based CPU that utilizes the multitasking Microsoft NT 4.0™ operating system.

In contrast and as an example, an IBM compatible personal computer of about fourteen years ago (at about the time that the Joehlin patent issued) utilized an Intel 386DX™ processor that only had a clock speed of 20 MHz, which is only one-eightieth of the currently available fastest clock speed (1.6 GHz), and at best could run on Microsoft Windows 3™, which was not capable of multitasking.

In about the timeframe of Blausey (i.e., about twenty-five years ago), an Intel 8086™ only had a clock speed of 10 MHz, which is only one one-hundred and sixtieth of the currently available fastest clock speed, and there was no IBM compatible personal computer. Consequently, twenty-five years ago Microsoft had no IBM compatible operating system to run on the Intel 8086.

Therefore, it is held that it would not have been technologically practical, until recently, to apply the enormous processing power that is required to obtain the real-time temperatures and make the necessary adjustments for automatically applying the present invention's controls and methods for the heating of the glass sheets.

Further, it is the present invention's discovery that utilizes the above-mentioned: 1) area temperature, 2) (if needed) core temperature, 3) adaptive, mathematically or historically, modeled desired temperature, 4) area setpoint temperature, 5) area temperature differences and/or area setpoint temperature differences, and 6) integral-only feedback controller, to quickly control overheating and under-heating of the glass sheets 20 for both the steady state operation and in handling the gaps. This control is achieved both preemptively and predictively.

In accordance with the provisions of the patent statutes, the principles and modes of operation of this invention have been described and illustrated in its preferred embodiments. However, it must be understood that the invention may be practiced otherwise than specifically explained and illustrated without departing from its spirit or scope.

1. An apparatus for controlling the heating of glass sheets being transported by a transport system in an enclosure having heaters, comprising:
at least one comparator in communication with the transport system and the heaters;
wherein the comparator utilizes area temperatures and area temperature differences to obtain furnace system demand;
further, wherein the comparator utilizes the furnace system demand to adjust the speed of the transport system, or the heat output of the heaters, or both;
thereby heating the glass sheets so that the area temperatures approach area desired temperatures.

2. An apparatus for controlling the heating of glass sheets being transported by a transport system in an enclosure having heaters, comprising:
at least one integral-only feedback controller in communication with the transport system and the heaters, wherein the integral-only feedback controller utilizes area temperatures to obtain furnace system demand;
further, wherein the integral-only feedback controller utilizes the furnace system demand to adjust the speed of the transport system, or the heat output of the heaters, or both;
thereby heating the glass sheets so that the area temperatures approach area desired temperatures.

3. An apparatus for controlling the heating of glass sheets being transported by at least one conveyor in an enclosure having heaters, comprising:
at least one processor in communication with the conveyor and the heaters;
at least one infrared thermal scanner in communication with the processor, the processor obtaining at least two discrete areas temperature signals from the scanner, thus providing area temperatures for the glass sheets; and
at least one integral-only feedback controller that is in communication with the processor, the integral-only feedback controller utilizing the discrete areas temperatures and area temperature differences, along with area desired temperatures, so as to obtain furnace system demand;
wherein the processor adjusts the speed of the conveyor, or the heat output of the heaters, or both, based on the furnace system demand;
thereby heating the glass sheets so that the area temperatures approach the area desired temperatures.

4. The apparatus for controlling the heating of glass sheets of claim 3, wherein discrete areas are defined as adjacent lanes.

5. The apparatus for controlling the heating of glass sheets of claim 3, wherein steady state area temperatures are within plus or minus 1 degree Fahrenheit of the area desired temperatures.

6. The apparatus for controlling the heating of glass sheets of claim 3, wherein steady state area temperatures are within plus or minus 1 degree Fahrenheit of the area desired temperatures, within 10 minutes after a return of glass sheets transporting following a gap.

7. The apparatus for controlling the heating of glass sheets of claim 3, wherein the glass sheets comprise automotive windshields and the thermal scanner utilizes electromagnetic signals from the heated windshields that correspond to the area temperatures on or near the surface of the heated windshields.

8. The apparatus for controlling the heating of glass sheets of claim 3, wherein the glass sheets comprise automotive side lites, back lites, or sun roofs, the heating controls further comprising at least one spot pyrometer in communication with the processor, wherein the spot pyrometer utilizes electromagnetic signals from the heated side lites, back lites, or sun roofs, that correspond to the core temperatures within the heated side lites, back lites, or sun roofs, and the integral-only feedback controller further utilizes the core temperatures in obtaining the furnace system demand.

9. The apparatus for controlling the heating of glass sheets of claim 3, wherein the integral-only feedback controller further utilizes adaptive mathematical modeling of the area desired temperature, or historical mathematical modeling of the area desired temperature, or both.

10. A method for controlling the heating of a glass sheet so that area temperatures approach area desired temperatures as the glass sheet is being transported by a transport system in an enclosure having heaters, comprising:
obtaining the area temperatures in at least two discrete areas for the sheet;
comparing the area temperatures to obtain area temperature differences, so as to obtain furnace system demand; and
adjusting the speed of the transport system, or the heat output of the heaters, or both, based on the furnace system demand;
thereby heating the sheet so that the area temperatures approach the area desired temperatures.

11. The method of claim 10, wherein the method elements are performed essentially continuously for precise heating.

12. A method for controlling the heating of a glass sheet so that area temperatures approach area desired temperatures as the glass sheet is being transported by a transport system in an enclosure having heaters, comprising:
obtaining the area temperatures in at least two discrete areas on the glass sheet;
applying integral-only feedback control to the area temperatures so as to obtain furnace system demand; and
adjusting the speed of the transport system, or the heat output of the heaters, or both, based on the furnace system demand;
thereby heating the glass sheet so that the area temperatures approach the area desired temperatures.

13. A method for controlling the heating of a glass sheet so that area temperatures approach area desired temperatures as the glass sheet is being transported by at least one conveyor in an enclosure having heaters, comprising:
utilizing at least one processor that is in communication with the conveyor and the heaters;
utilizing at least one infrared thermal scanner that is in communication with the processor, the processor obtaining at least two discrete area temperature signals from the infrared thermal scanner, and providing area temperatures and area temperature differences for the sheet;
utilizing an integral-only feedback controller that is in communication with the processor, wherein the integral-only feedback controller utilizes the area temperatures and the area temperature differences so as to obtain furnace system demand; and
adjusting the speed of the conveyor, or the heat output of the heaters, or both, based on the furnace system demand;
thereby heating the glass sheet so that the area temperatures approach the area desired temperatures.

14. The method of claim 13, wherein steady state area temperatures are within plus or minus 1 degree Fahrenheit of area desired temperatures.

15. The method of claim 13, wherein steady state area temperatures are within plus or minus 1 degree Fahrenheit of area desired temperatures, within 10 minutes after a return of glass sheet transporting following a gap.

16. The method of claim 13, wherein the glass sheet comprises an automotive windshield and the thermal scanner utilizes electromagnetic signals received from the heated windshield, thus providing the glass area temperatures that are on or near to a surface of the glass sheet.

17. The method of claim 13, further comprising:
utilizing at least one spot pyrometer that is in communication with the processor;
wherein the glass sheet comprises automotive side lites, back lites, or sun roofs and the infrared thermal scanner utilizes electromagnetic signals received from the heated glass that provide area temperatures, and the spot pyrometer utilizes electromagnetic signals from the heated glass that provide core temperatures.

18. The method of claim 13, wherein the area desired temperatures further include adaptive mathematical modeling of the area desired temperature, or historical mathematical modeling of the area desired temperature, or both.

19. The method of claim 13, wherein the discrete areas are defined as adjacent lanes.
